(19) United States
(12) Patent Application Publication
(10) Pub. No.: US 2007/0212439 A1
(43) Pub. Date: Sep. 13, 2007

(54) Molding Apparatus

(75) Inventor: Tsung-Wei Chiang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,897

(22) Filed: Oct. 24, 2006

(30) Foreign Application Priority Data
Dec. 30, 2005 (CN) 200510121416.X

(51) Int. Cl. B28B 7/28

(52) U.S. Cl. 425/468; 425/182

(57) ABSTRACT

A molding apparatus includes a fixed mold part including a first mold core and a frustoconical recess defined therein and having a first molding surface in the frustoconical recess. A movable mold part is configured for alignment with and attachment to the fixed mold part, and defines a first through hole therein. A movable core module is received in the first through hole and includes a main body having a frustoconical protrusion with a receiving hole defined therein, and a second mold core received in the receiving hole in the frustoconical protrusion. The second mold core has a second molding surface. The frustoconical protrusion can be matingly engaged in the frustoconical recess, thus aligning the first molding surface with the second molding surface and defining a molding chamber therebetween.

### FIELD OF THE INVENTION

The present invention relates to molding apparatuses and, more particularly, to a molding apparatus with high concentricity.

### DESCRIPTION OF RELATED ART

Molding apparatuses are widely used for manufacturing optical articles, such as light guide plates, lenses, and so on. For lenses, concentricity of the two opposing surfaces is an important factor in molding precision.

Referring to FIG. 6, a conventional molding apparatus 100 for molding an optical lens 140 includes a fixed mold part 110 and a movable mold part 120 facing the fixed mold part 110. The fixed mold part 110 has a first molding surface 112 defined on one surface thereof facing towards the movable mold part 120. The movable mold part 120 has a second molding surface 124 defined on one surface thereof facing towards the fixed mold part 110. The first molding surface 112 is aligned with the second molding surface 124 and a molding chamber is defined therebetween. Two fixing blocks 127 are formed on the movable mold part 120 and two location holes 116 corresponding to the fixing blocks 127 are defined on the fixed mold part 110. The fixing blocks 127 are matingly engaged in the location holes 116 to give the molding apparatus 100 good concentricity. However, the concentricity of the molding apparatus 100 may lessen after repeated sinking and re-assembly of the fixed mold part 110 and the movable mold part 120 due to wear and tear on the fixing blocks 127 and the fixed mold part 110.

What is needed, therefore, is a molding apparatus that can produce a greater number of products with constant and accurate concentricity and/or precision.

### SUMMARY OF THE INVENTION

In a preferred embodiment of the present invention, a molding apparatus includes a fixed mold part, a movable mold part and a movable core module. The fixed mold part includes a first mold core and a frustoconical recess defined therein and has a first molding surface in the frustoconical recess. The movable mold part is configured for alignment with and attachment to the fixed mold part and defines a first through hole therein and is shaped so as to conform with a shape of the frustoconical recess. The movable core module is received in the first through hole and includes a main body having a frustoconical protrusion with a receiving hole defined therein, and a second mold core received in the receiving hole in the frustoconical protrusion. The second mold core has a second molding surface, and the frustoconical protrusion is configured (i.e., structured and arranged) for extending through the first through hole of the movable mold part and being matingly engaged in the frustoconical recess. The first molding surface can thus be aligned with the second molding surface and defines a molding chamber therebetween.

Advantages and novel features will become more apparent from the following detailed description of the present molding apparatus, when taken in conjunction with the accompanying drawings.

### BRIEF DESCRIPTION OF THE DRAWINGS

Many aspects of the present molding apparatus can be better understood with reference to the following drawings. The components in the drawings are not necessarily drawn to scale, the emphasis instead being placed upon clearly illustrating the principles of the present molding apparatus. Moreover, in the drawings, like reference numerals designate corresponding parts throughout the several views.

FIG. 1 is a schematic, exploded cross-sectional view of a molding apparatus in accordance with a preferred embodiment;

FIG. 2 is a schematic, cross-sectional view of the assembled molding apparatus shown in FIG. 1;

FIG. 3 is an enlarged view of a circled section III of the molding apparatus of FIG. 2;

FIG. 4 is a schematic, cross-sectional view of the molding apparatus shown in FIG. 1 showing the fixed mold part assembled with the movable mold part;

FIG. 5 is a schematic, cross-sectional view of an optical lens produced by the molding apparatus shown in FIG. 1; and

FIG. 6 is a schematic, cross-sectional view of a conventional molding apparatus.

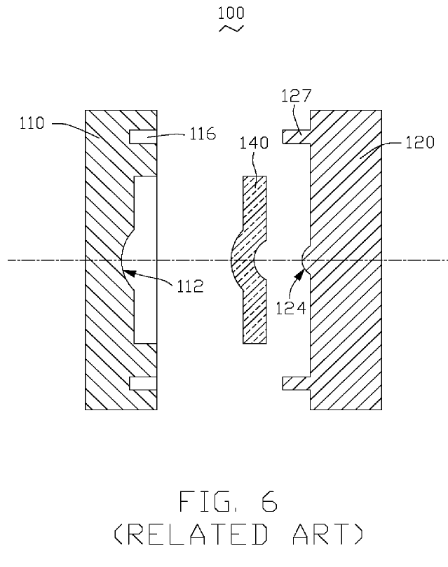

### DETAILED DESCRIPTION OF THE INVENTION

Reference will now be made to the drawings to describe preferred embodiments of the present molding apparatus.

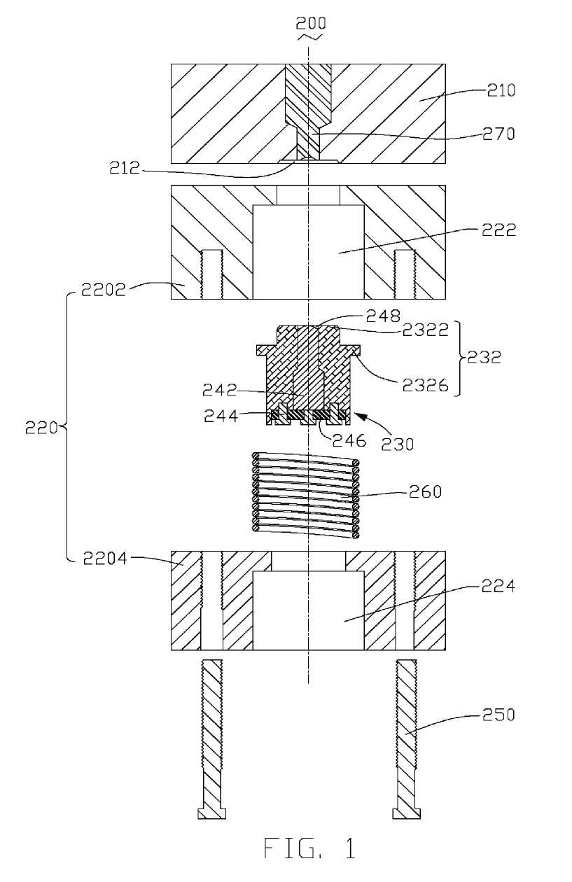

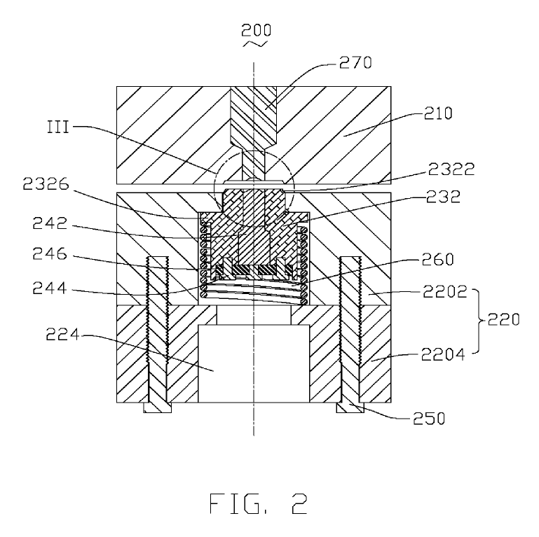

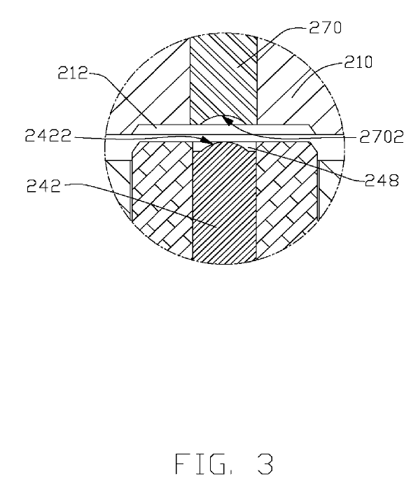

FIGS. 1 to 3 illustrate a molding apparatus 200 in accordance with a preferred embodiment. The molding apparatus 200 includes a fixed mold part 210, a movable mold part 220 and a movable core module 230.

The fixed mold part 210 is arranged facing the movable mold part 220. A first mold core 270 and a frustoconical recess 212 are defined in the fixed mold part 210. The first mold core 270 has a first molding surface 2702 in the frustoconical recess 212. The first molding surface 2702 and the frustoconical recess 212 are both adjacent to the movable mold part 220.

The movable mold part 220 is configured for alignment with and attachment to the fixed mold part 210 and includes a movable core module receiving part 2202 and a base part 2204. The movable core module receiving part 2202 and the base part 2204 define a first through hole 222 and a second through hole 224 therein separately and each should preferably include a stepped structure in the through holes 222 and 224. Additionally, the movable core module receiving part 2202 and the base part 2204 can be coupled together with a plurality of bolts 250.

The movable core module 230 includes a main body 232 and a second mold core 242. The main body has a frustoconical protrusion 2322 with a receiving hole 248 defined therein and includes a flange 2326 on an outer surface thereof, which is configured for abutting against the stepped structure in the first through hole 222. The frustoconical protrusion 2322 is configured for extending through the first through hole 222 of the movable mold part 220 and is shaped so as to conform with a shape of the frustoconical recess 212. The receiving hole 248 is defined in the middle axis of the main body 232 and a second mold core 242 is received in the receiving hole 248. The second mold core 242 has a second molding surface 2422 on one end thereof facing the first molding surface 2702. The first molding surface 2702 and the second molding surface 2422 can be both spherical or non-spherical.

A supporting plate 246 contacts one end of the second mold core 242 adjacent to the base part 2204 and is configured for supporting the second mold core 242 thereon in the receiving hole 248. The supporting plate 246 is connected with the second mold core 242 by a connecting screw 2442 and is coupled to the movable core module 230 by means of at least an adjusting screw 2444. The adjusting screw 2444 is configured for adjusting a position of the supporting plate 246 relative to the main body 232. A resilient member such as, for example, a spring 260 is arranged between the flange 2326 and the base part 2204. When the movable core part 220 is assembled, two ends of the spring 260 contact the flange 2326 and base part 2204 separately and the spring 260 is compressed so as to bring the main body 232 into firm contact with the movable core module receiving part 2202.

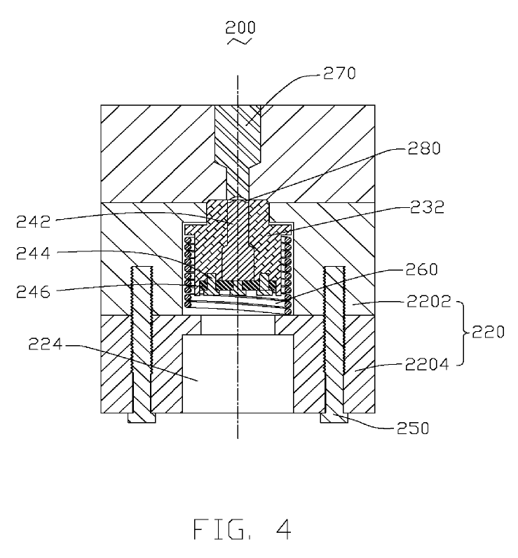

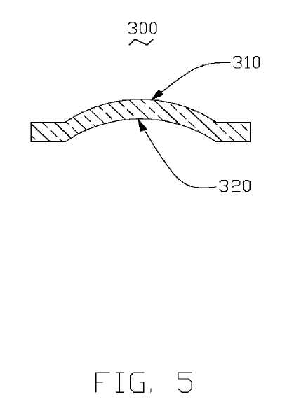

Referring to FIG. 4, the frustoconical protrusion 2322 is matingly engaged in the frustoconical recess 212 in a manner such that the first molding surface 2702 is aligned with the second molding surface 2422 and a molding chamber 280 is defined therebetween. A shape of the molding chamber 280 is that of a molded component with a predetermined shape. In this preferred embodiment, an optical lens 300 is taken as an example as shown in FIG. 5. The optical lens 300 has two opposing molded surfaces 310 and 320 mated to the first molding surface 2702 and the second molding surface 2422 respectively. Centers of sphere of the two opposite molded surfaces 310 and 320 are in-line with an optical axis of the optical lens 300. During molding, molding materials (e.g. glass or plastic) are injected into the molding chamber 280 through a sprue gate (not shown) and then the optical lens 300 is formed. The second through hole 224 is configured for allowing access of the adjusting screw there through, therefore, a thickness of the molding chamber 280 can be easily changed. It is to be understood that the two opposing surfaces 310 and 320 of the optical lens 300 also can be non-spherical.

The present molding apparatus 200 has a good concentricity even after prolonged use because the frustoconical protrusion is matingly engaged with the frustoconical recess 212 and less wear occurs between the frustoconical protrusion 2322 and the frustoconical recess 212.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A molding apparatus comprising:
a fixed mold part comprising a first mold core and a frustoconical recess defined therein, the first mold core having a first molding surface in the frustoconical recess;
a movable mold part configured for alignment with and attachment to the fixed mold part, the movable mold part defining a first through hole therein; and
a movable core module received in the first through hole, the movable core module comprising
a main body having a frustoconical protrusion with a receiving hole defined therein, the frustoconical protrusion being shaped so as to conform with a shape of the frustoconical recess, and
a second mold core received in the receiving hole in the frustoconical protrusion, the second mold core having a second molding surface, the frustoconical protrusion being configured for extending through the first through hole of the movable mold part and being matingly engaged in the frustoconical recess, thus aligning the first molding surface with the second molding surface and defining a molding chamber is therebetween.

2. The molding apparatus as claimed in claim 1, wherein the movable mold part comprises a stepped structure in the first through hole.

3. The molding apparatus as claimed in claim 1, wherein the movable mold part comprises a movable core module receiving part with the first through hole defined therein, and a base part being coupled to the movable core module receiving part.

4. The molding apparatus as claimed in claim 2, wherein the movable core module comprises a flange formed on the main body thereof configured for abutting against the stepped structure in the first through hole main body.

5. The molding apparatus as claimed in claim 1, wherein the movable core module further comprises at least one adjusting screw and a supporting plate coupled to the main body by means of the at least one adjusting screw, the supporting plate being configured for supporting the second mold core thereon in the receiving hole, the at least one adjusting screw being configured for adjusting a position of the supporting plate relative to the main body.

6. The molding apparatus as claimed in claim 5, wherein the base part has a second through hole configured for allowing access of the at least one adjusting screw therethrough.

7. The molding apparatus as claimed in claim 6, wherein the base part comprises a stepped structure in the second through hole.

8. The molding apparatus as claimed in claim 4, further comprising a resilient member arranged between the flange of the movable core module and the base part.

9. The molding apparatus as claimed in claim 8, wherein the resilient member is a spring.
